(19) United States
(12) Patent Application Publication
(10) Pub. No.: US 2025/0329766 A1
(43) Pub. Date: Oct. 23, 2025

(54) Fresh Water Production and Thermally Regenerative Electrochemical Cycle Using Multiple Stages of Thermally Responsive Mixtures

(71) Applicant: Georgia Tech Research Corporation, Atlanta, GA (US)

(72) Inventor: Jordan D. Kocher, Atlanta, GA (US)

(21) Appl. No.: 18/913,551

(22) Filed: Oct. 11, 2024

Related U.S. Application Data
(60) Provisional application No. 63/637,411, filed on Apr. 23, 2024.

(51) Int. Cl. H01M 8/22; B01D 61/00; C02F 1/44; C02F 103/08

(52) U.S. Cl. CPC H01M 8/227; B01D 61/0021; B01D 61/0022; C02F 1/445; B01D 2311/06; B01D 2313/501; C02F 2103/08; C02F 2301/08

(57) ABSTRACT

An exemplary embodiment of the present disclosure provides a desalination system. The desalination system may comprise a first liquid reservoir. The desalination system may also comprise a first heater. The desalination system may also comprise a second liquid reservoir. The desalination system may further comprise a second heater. Another exemplary embodiment of the present disclosure provides a power generation system. The power generation system may comprise a first liquid reservoir. The power generation system may also comprise a first thermally responsive liquid.

### CROSS-REFERENCE TO RELATED APPLICATIONS

This application claims the priority benefit of U.S. Provisional Patent Application Ser. No. 63/637,411, filed Apr. 23, 2024, which is hereby incorporated by reference in its entirety.

### STATEMENT REGARDING FEDERALLY SPONSORED RESEARCH OR DEVELOPMENT

This invention was made with government support under grant/award number DOE-EERE-RPP-IBUILD-2020 awarded by the Department of Energy. The government has certain rights in the invention.

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates generally to systems and methods, and more particularly to freshwater production systems and regenerative electrochemical cycles with thermally responsive liquids.

### 2. Description of Related Art

Desalination is a widely used method of producing fresh water. Reverse osmosis is the standard for seawater desalination systems in terms of cost and efficiency. When desalinating inland feed water (e.g., saline surface water and groundwater, oil and gas wastewater, etc.), it is important to remove as much water from the feed as possible, to reduce the amount of brine that has to be disposed of (a costly process when far from the ocean). However, reverse osmosis is not able to remove a sufficient amount water from the feed, since that would require pressures that are far higher than what current reverse osmosis membranes can withstand. There are certain materials that will mix with water (like salt) at ambient temperatures, but then separate from the water (like oil) at higher temperatures. The temperature at which these mixtures start separating is known as the lower critical solution temperature (LCST). These LCST mixtures have been used for desalination in previous inventions and journal papers. However, the LCST materials and systems that have been used for desalination in the past have only been able to desalinate water that is less than 10% salt by weight. For inland desalination to be cost effective, the desalination system must be able to desalinate water that is up to 26% salt by weight.

Additionally, heat-driven power cycles form the basis of our energy grid. Many of these are turbines, driven by the combustion of fossil fuels, though these produce significant greenhouse gas emissions. Meanwhile, solar panels produce electricity without emissions, but sunlight is intermittent, so they cannot produce the precise amount of power needed to meet the grid's demands without storage, which is currently costly. Concentrating solar power plants heat up a working fluid that then delivers heat to spin a turbine. The hot working fluid can be stored, so that the system can provide dispatchable, round-the-clock power. However, these systems are expensive, requiring many concentrating mirrors to reach high temperatures.

Thus, technological innovation is needed to provide systems and methods of desalinating via desalination systems and generating power through regenerative electrochemical cycles that overcome the limitations of the conventional systems and methods. Thus, one focus of the present invention is to provide a desalination system with a thermally responsive liquid and a thermally regenerative electrochemical cycle with a thermally responsive liquid.

### SUMMARY OF THE INVENTION

An exemplary embodiment of the present disclosure provides a system for desalinating a liquid. The desalination system may comprise a first liquid reservoir comprising a first chamber and a second chamber. The first chamber may be configured to receive a first saline liquid having a first salt concentration, and the second chamber may be configured to receive a first thermally responsive liquid comprising a second salt concentration. The second salt concentration may be less than the first salt concentration. In various embodiments, the first thermally responsive liquid is configured to absorb water from the first saline liquid. The desalination system may further comprise a first heater configured to heat the first thermally responsive liquid to separate the first thermally responsive liquid into a first water-scarce phase liquid and a first water-rich phase liquid. The first water-rich phase liquid may comprise a third salt concentration less than the first salt concentration.

The desalination system may further comprise a second liquid reservoir comprising a first chamber and a second chamber. The first chamber may be configured to receive the first water-rich phase liquid, and the second chamber may be configured to receive a second thermally responsive liquid having a fourth salt concentration less than the third salt concentration. The second thermally responsive liquid may be configured to absorb water from the first water-rich phase. The desalination system may also comprise a second heater configured to heat the second thermally responsive liquid to separate the second thermally responsive liquid into a second water-scarce phase liquid and a second water-rich phase liquid. The second water-rich phase liquid may comprise a fifth salt concentration less than the third salt concentration.

In any of the embodiments disclosed herein, the first and/or the second heater may comprise one or more of solar heat, waste heat, gas heat, electric heat, or a combination thereof.

In any of the embodiments disclosed herein, the desalination system may further comprise a first separator configured to separate the first thermally responsive liquid into the first water-scarce phase liquid and the first water-rich phase liquid. In any of the embodiments disclosed herein, the desalination system may also comprise a second separator configured to separate the second thermally responsive liquid into the second water-scarce phase liquid and the second water-rich phase liquid.

In any of the embodiments disclosed herein, the first separator may be in fluid communication with the second chamber of the first liquid reservoir. The first separator may be configured to receive the first thermally responsive fluid with the absorbed water from the first saline liquid and return the first water-scarce phase liquid to the second chamber of the first liquid reservoir.

In any of the embodiments disclosed herein, the first separator may be in fluid communication with the second liquid reservoir. The first separator may be configured to deliver the first water-rich phase liquid to the first chamber of the second liquid reservoir.

In any of the embodiments disclosed herein, the second separator may be in fluid communication with the second chamber of the second liquid reservoir. The second separator may be configured to receive the second thermally responsive fluid with the absorbed water from the first water-rich phase liquid and return the second water-scarce phase liquid to the second chamber of the second liquid reservoir.

In any of the embodiments disclosed herein, the second separator may be in fluid communication with a third liquid reservoir. The second separator may be configured to deliver the second water-rich phase liquid to the third liquid reservoir.

In any of the embodiments disclosed herein, the first liquid reservoir may comprise at least one membrane. The first liquid reservoir may be configured such that water from the first saline liquid in the first chamber diffuses through the at least one membrane and into the first thermally responsive liquid in the second chamber.

In any of the embodiments disclosed herein, the second liquid reservoir comprises at least one membrane. The second liquid reservoir may be configured such that water from the first water-rich phase liquid in the first chamber diffuses through the at least one membrane and into the second thermally responsive liquid in the second chamber.

In any of the embodiments disclosed herein, the system may be configured to take salt collected by the at least one membrane of the second liquid reservoir and inject the salt into the first thermally responsive liquid in the second chamber of the first liquid reservoir.

In another exemplary embodiment of the present disclosure provides a power generation system. The power generation system may comprise a first liquid reservoir comprising at least one membrane dividing the first liquid reservoir into a first chamber and a second chamber. The power generation system may also comprise a first thermally responsive liquid having a first lower critical solution temperature (LCST) within at least a portion of the first liquid reservoir. The first thermally responsive liquid may be configured to be separated into a first water-scarce phase liquid and a first water-rich phase liquid upon heating. The first water-scarce phase liquid and the first water-rich phase liquid may comprise different chemical potentials. The portion of the first water-scarce phase liquid may be configured to flow from the first chamber, through the at least one membrane, and to the second chamber. The power generation system may also comprise a first electrode and a second electrode. In various embodiments, at least one electron may be configured to flow from the first electrode to the second electrode to generate electrical power.

In any of the embodiments disclosed herein, the at least one membrane may be one or more of a cation exchange membrane, a water-permeable membrane, or a combination thereof and may be configured to selectively allow the first thermally responsive liquid cations to pass.

In any of the embodiments disclosed herein, the first electrode may be disposed at least partially within the first chamber. The first chamber may house either of the first water-scarce phase liquid or the first water-rich phase liquid. The second electrode may be disposed at least partially within the second chamber of the first liquid reservoir. The second chamber may house either of the first water-scarce phase liquid or the first water-rich phase liquid.

In any of the embodiments disclosed herein, the system may further comprise a first heater configured to heat the first thermally responsive liquid to a temperature that is at least the first LCST to separate the first thermally responsive liquid into the first water-scarce phase liquid and the first water-rich phase liquid.

In any of the embodiments disclosed herein, the first heater may comprise one or more of solar heat, waste heat, gas heat, electric heat, or a combination thereof.

In any of the embodiments, the system may further comprise a first separator configured to separate the first thermally responsive liquid into the first water-scarce phase liquid and the first water-rich phase liquid.

In any of the embodiments, the system may further comprise a second liquid reservoir disposed at least partially within the first liquid reservoir and comprising at least one additional membrane dividing the second liquid reservoir into a second first chamber and a second chamber. The at least one additional membrane may be one or more of a cation exchange membrane, a water-permeable membrane, or a combination thereof. In various embodiments, the system may also comprise an aqueous electrolyte having a second lower critical solution temperature (LCST) within at least a portion of the second liquid reservoir. The aqueous electrolyte may be configured to be separated into a weak aqueous electrolyte phase liquid and a strong aqueous electrolyte phase liquid. The system may also comprise a second heater configured to heat the aqueous electrolyte to a temperature that is at least the second LCST to separate the aqueous electrolyte into the weak aqueous electrolyte phase liquid and the strong aqueous electrolyte phase liquid. The second heater may comprise one or more of solar heat, waste heat, gas heat, electric heat, or a combination thereof. The system may further comprise a second separator configured to separate the aqueous electrolyte into the weak aqueous electrolyte phase liquid and the strong aqueous electrolyte phase liquid.

In any of the embodiments, the first electrode may be disposed at least partially within the second first chamber of the second liquid reservoir. The second first chamber houses either the weak aqueous electrolyte phase liquid or the strong aqueous electrolyte phase liquid and/or the second electrode may be disposed at least partially within the second chamber of the second liquid reservoir. The second chamber may house either the weak aqueous electrolyte phase liquid and the strong aqueous electrolyte phase liquid.

In any of the embodiments, the first membrane may be a water-permeable membrane and diffuses water to flow from the first thermally responsive liquid within at least a portion of the first liquid reservoir, through the first membrane, and to the aqueous electrolyte within at least a portion of the second liquid reservoir and/or from the aqueous electrolyte within at least a portion of the second liquid reservoir, through the first membrane, and to at least a portion of the first thermally responsive liquid within at least a portion of the first liquid reservoir.

In any of the embodiments, the at least one additional membrane may be configured to allow at least one cation to flow through the at least one additional membrane. The at least one anion may be configured to flow to the first electrode and/or to the second electrode. The flow of the at least one anion may be configured to generate electrical power.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings. Reference will now be made to the accompanying figures and flow diagrams, which are not necessarily drawn to scale.

FIG. 1A illustrates an exemplary schematic of a portion of a desalination system in accordance with various embodiments of the present disclosure.

FIG. 1B illustrates an exemplary schematic of a portion of a desalination system in accordance with various embodiments of the present disclosure.

FIG. 2A illustrates an exemplary schematic of a portion of a desalination system in accordance with various embodiments of the present disclosure.

FIG. 2B illustrates an exemplary schematic of a portion of a desalination system in accordance with various embodiments of the present disclosure.

FIG. 3 illustrates an exemplary schematic of a multistage desalination system in accordance with various embodiments of the present disclosure.

FIG. 4A illustrates an exemplary schematic of a portion of a multistage desalination system in accordance with various embodiments of the present disclosure.

FIG. 4B illustrates an exemplary schematic of a portion of a multistage desalination system in accordance with various embodiments of the present disclosure.

FIG. 5A illustrates an exemplary phase diagram for a thermally responsive liquid in accordance with various embodiments of the present disclosure.

FIG. 5B illustrates an exemplary phase diagram for a thermally responsive liquid in accordance with various embodiments of the present disclosure.

FIG. 6A illustrates an exemplary schematic of a regenerative electrochemical cycle system in accordance with various embodiments of the present disclosure.

FIG. 6B illustrates an exemplary schematic of a multistage regenerative electrochemical cycle system in accordance with various embodiments of the present disclosure.

FIG. 7A illustrates an exemplary phase diagram for a thermally responsive liquid in accordance with various embodiments of the present disclosure.

FIG. 7B illustrates an exemplary phase diagram for a thermally responsive liquid in accordance with various embodiments of the present disclosure.

FIG. 8 illustrates an exemplary phase diagram for a thermally responsive liquid in accordance with various embodiments of the present disclosure.

FIG. 9 graphically illustrates liquid activity as a function of charge and voltage as a function of cell charge in accordance with various embodiments of the present disclosure.

### DETAILED DESCRIPTION OF THE INVENTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Also, in describing the preferred exemplary embodiments, terminology will be resorted to for the sake of clarity. It is intended that each term contemplates its broadest meaning as understood by those skilled in the art and includes all technical equivalents that operate in a similar manner to accomplish a similar purpose.

As used in the specification and the appended claims, the singular forms “a,” “an” and “the” include plural referents unless the context clearly dictates otherwise. References to a composition containing “a” constituent is intended to include other constituents in addition to the one named.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not imply that the methods steps must be performed in a particular order or preclude the presence of additional method steps or intervening method steps between the steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter. Additionally, the components described herein may apply to any other component within the disclosure. Merely discussing a feature or component in relation to one embodiment does not preclude the feature or component from being used or associated with another embodiment.

To facilitate an understanding of the principles and features of the disclosure, various illustrative embodiments are explained below. In particular, the presently disclosed subject matter is described in the context of systems and methods for desalinating water and thermally regenerative electrochemical cycle and, more particularly, to the use of thermally responsive liquids. In some embodiments, the systems and methods may be described in the context of water generation and electrochemical cells to generate electrical power. For example, some examples of the present disclosure may improve upon desalination systems and regenerative electrochemical cycles. Accordingly, when the present disclosure is described in the context of desalination systems and regenerative electrochemical cycles with thermally responsive liquids, it will be understood that other embodiments can take the place of those referred to.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

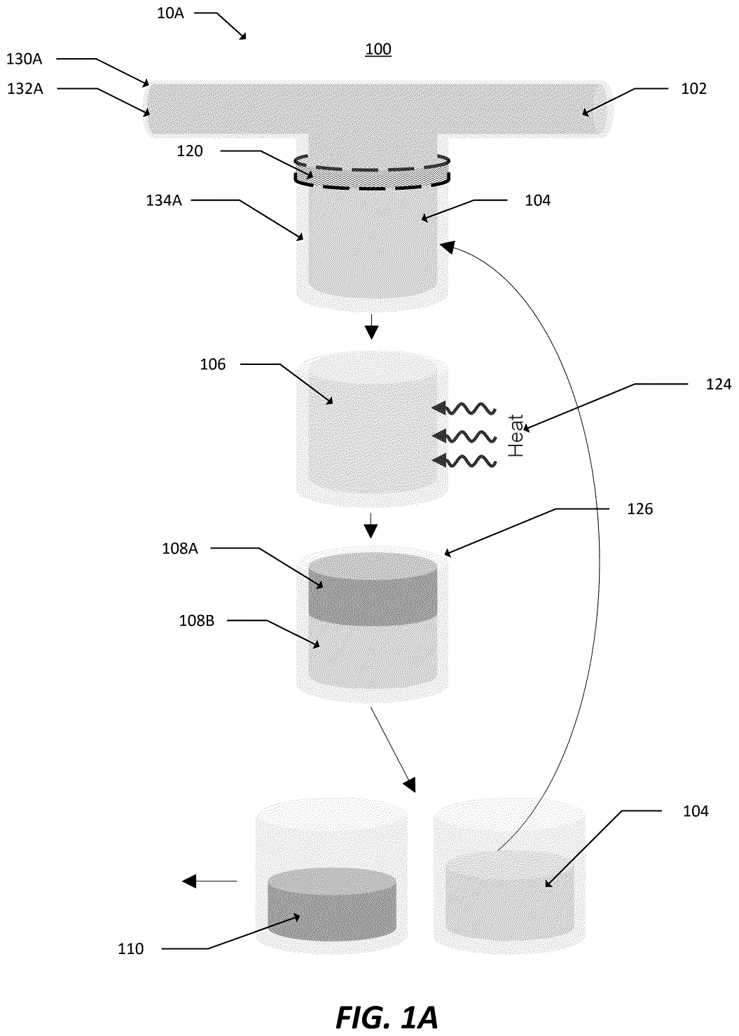

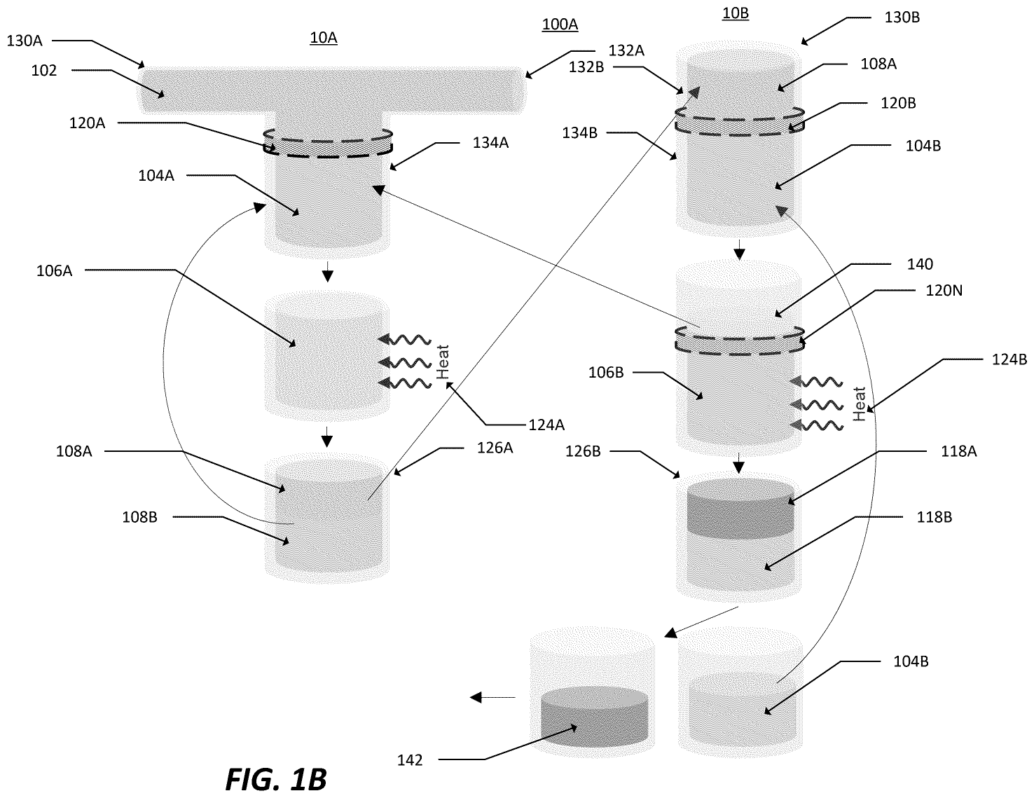

FIG. 1A illustrates a portion of an exemplary system 100 (e.g., desalination system) in accordance with various embodiments of the present disclosure. In various embodiments, the desalination system 100 may comprise at least a first stage 10A. In one or more embodiments, the desalination system 100 may comprise at least a first stage 10A and/or at least one additional stage (e.g., 10B, depicted in FIG. 1B). The desalination system 100 may further comprise at least a first liquid reservoir 130A and/or one or more additional liquid reservoir (e.g., second liquid reservoir, third liquid reservoir, etc.). In various embodiments, the desalination system 100 may receive a first saline liquid 102 (e.g., high salinity liquid) and/or a first thermally responsive liquid having a first low critical solution temperature (LCST). In various embodiments, the first stage 10A may comprise a first liquid reservoir 130A. The first liquid reservoir 130A may comprise a first chamber 132A and a second chamber 134A, such that the first chamber 132A may be configured to at least partially receive a first saline liquid 102 having a first salt concentration. In various embodiments, the second chamber 134A may be configured to receive a first thermally responsive liquid 104 having a second salt concentration, such that the second salt concentration may be different (e.g., less than or greater than) than the first salt concentration. In various embodiments, the first thermally responsive liquid may be configured to at least partially absorb liquid (e.g., water) from the first saline liquid 102, such that the liquid absorbed with the first thermally responsive liquid 104 may comprise a lower salt concentration than the first saline liquid.

In various embodiments, the first liquid reservoir 130A may further comprise at least one membrane 120. The at least one membrane 120 may divide the first liquid reservoir 130A into the first chamber 132A and the second chamber 134A. In various embodiments, the at least one membrane comprise one or more of a desired shape, configuration, thickness, material, or a combination thereof to perform the desired function. In one or more embodiments, that least one membrane 120 may extend along the entire height of the first liquid reservoir 130A. In one or more embodiments, that least one membrane 120 may extend along the entire width of the first liquid reservoir 130A. In one or more embodiments, the at least one membrane 120 may be configured to extend along one or more of the entire height, width, depth, or a combination thereof of the first liquid reservoir. In various embodiments, the at least one membrane is one or more of a cation exchange membrane, a water-permeable membrane, or a combination thereof. In various embodiments, the at least one membrane 120 may be configured to selectively allow water from the first saline liquid 102 in the first chamber to diffuse through the at least one membrane and into the first thermally responsive liquid in the second chamber.

In various embodiments, the first thermally responsive liquid 104 may be a moderate phase liquid, such that the moderate phase liquid can be separated into a first water-scarce phase liquid 108B and a first water-rich phase liquid 108A upon heating. In various embodiments, the first thermally responsive liquid may comprise first low critical solution temperature (LCST) 104 and/or a first predetermined concentration of salt. The first predetermined concentration may be configured to change one or more properties of the first thermally responsive liquid 104. In various embodiments, the first predetermined concentration of salt may change (e.g., increase or decrease) the absorption property of the first thermally responsive liquid 104. In various embodiments, the salt may be lithium chloride.

In various embodiments, the first stage 10A of the desalination system 100 may further comprise a first heater 124 and/or a first separator 126. The first heater 124 may be configured to transfer heat to the moderate phase liquid 106 (e.g., first thermally responsive liquid with the absorbed water) to separate the moderate phase liquid 106 into the first water-scarce phase liquid 108B and the first water-rich phase liquid 108A. In various embodiments, the first heater 124 may utilize one or more of solar heat, waste heat, gas heat, electric heat, or a combination thereof. Additionally, the first separator 126 may be configured to physically separate the first water-scarce phase liquid 108B and the first water-rich phase liquid 108A. In various embodiments, the first water-rich phase liquid 108A may be nearly pure drinking water 110 upon being separated from the first water-scarce phase liquid 108B. In various embodiments, the first water-scarce phase liquid 108B may be separated back into the first thermally responsive liquid 104, such that the first thermally responsive liquid may be reused to absorb more water from the first saline liquid 102.

FIG. 1B illustrates a multistage desalination system 100A in accordance with various embodiments of the present disclosure. In various embodiments, the multistage desalination system 100A may comprise a first stage 10A (e.g., described with reference to FIG. 1A) and/or at least one additional stage (e.g., second stage 10B). In various embodiments, the second stage 10B of the desalination system 100A may further comprise a second liquid reservoir 130B and/or one or more additional liquid reservoir (e.g., third liquid reservoir, fourth liquid reservoir, etc.). In various embodiments, the second stage 10B of the desalination system 100 may be configured to receive a second saline liquid (e.g., first water-rich phase liquid) and/or a second thermally responsive liquid 104B having a second low critical solution temperature (LCST). In one or more embodiments, the first LCST and the second LCST may be the same. In other embodiments, the first LCST and the second LCST may be different. In various embodiments, the second saline liquid (e.g., first water-rich phase liquid 108A) may comprise a third salt concentration, such that the third salt concentration is less than the first salt concentration (e.g., less than the salt concentration of the first saline liquid) and/or the second salt concentration.

In various embodiments, the second liquid reservoir 130B may comprise a first chamber 132B and a second chamber 134B. The first chamber 132B may be configured to at least partially receive the first water-rich phase liquid 108A from the first separator 126A, such that the first chamber 132B of the second liquid reservoir 130B may be fluidically communicative with the first separator 126A. In various embodiments, the second chamber 134B may be configured to receive a second thermally responsive liquid 104B having a fourth salt concentration, such that the fourth salt concentration may be different (e.g., less than or greater than) than one or more of the first, second, third salt concentration, or a combination thereof. In various embodiments, the second thermally responsive liquid 104B may be configured to at least partially absorb liquid (e.g., water) from the first water-rich phase liquid 108A.

In various embodiments, the second liquid reservoir 130B may further comprise at least one additional membrane 120B. The at least one membrane additional 120B may divide the second liquid reservoir 130B into the first chamber 132B and the second chamber 134B. The at least one additional membrane 120B may comprise one or more of a desired shape, configuration, thickness, material, or a combination thereof to perform the desired function. In one or more embodiments, the at least one additional membrane 120B may extend along the entire height of the second liquid reservoir 130B. In one or more embodiments, that least one additional membrane 120B may extend along the entire width of the second liquid reservoir 130B.

In one or more embodiments, the at least one additional membrane 120B may be configured to extend along one or more of the entire height, width, depth, or a combination thereof of the second liquid reservoir. The at least one additional membrane 120B may be one or more of a cation exchange membrane, a water-permeable membrane, or a combination thereof. In various embodiments, the at least one additional membrane 120B may be configured to selectively allow water from the first water-rich phase liquid 108A in the first chamber 132B to diffuse through the at least one additional membrane 120B and into the second thermally responsive liquid 104B in the second chamber 134B. In one or more embodiments, the at least one additional membrane 120B and/or 120N may be configured to separate salt from the first water-rich phase liquid 108A, such that the salt 140 may be injected back into the first thermally responsive liquid 104A in the second chamber 134A of the first liquid reservoir 130A and/or back into the second thermally responsive liquid 104B in the second chamber 134B of the second liquid reservoir 130B.

In various embodiments, the desalination system 100A may further comprise a second heater 124B and/or a second separator 126B. In various embodiments, second thermally responsive liquid 104B may be a moderate phase liquid 106B (e.g., second thermally responsive liquid comprising water absorbed from the first-water rich phase liquid) configured to be separated into a second water-scarce phase liquid 118B and a second water-rich phase liquid 118A upon heating. In various embodiments, the second thermally responsive liquid 104B may comprise a second low critical solution temperature (LCST) 104B and/or a fourth predetermined concentration of salt. The fourth predetermined concentration may be configured to change one or more properties of the second thermally responsive liquid. In various embodiments, the fourth predetermined concentration of salt may change (e.g., increase or decrease) the absorption property of the second thermally responsive liquid. In various embodiments, the salt may be lithium chloride.

In various embodiments, the second heater 124B may be configured to transfer heat to the second moderate phase liquid 106B (e.g., second thermally responsive liquid with the absorbed water) to separate the second moderate phase liquid 106B into the second water-scarce phase liquid 118B and the second water-rich phase liquid 118A. The second heater 124B may be configured to utilize one or more of solar heat, waste heat, gas heat, electric heat, or a combination thereof. In various embodiments, the second separator 126B may physically separate the second water-scarce phase liquid 118B and the second water-rich phase liquid 118A. The second separator 126B may be in fluid communication with the second chamber 134 of the second liquid reservoir 130B. In various embodiments, the second separator 126B may be configured to receive the second thermally responsive fluid with the absorbed water from the second water-rich phase liquid 118A and return the second water-scarce phase liquid 118B to the second chamber 134B of the second liquid reservoir 130B. In one or more embodiments, the second separator 126B may be in fluid communication with a third liquid reservoir (not depicted), such that the second separator 126B may be configured to deliver the second water-rich phase liquid 118A to the third liquid reservoir.

In various embodiments, the second water-rich phase liquid 118A may be nearly pure drinking water 142 upon being separated from the second water-scarce phase liquid 118B. In various embodiments, the second water-scarce phase liquid 118B may be separated and pumped back into the second chamber 134B of the second liquid reservoir 130B, such that the second thermally responsive liquid 104B may be reused to absorb more water from the first water-rich phase liquid 108A. In various embodiments, the desalination system 100 may further comprise one or more additional stages, such that the one or more additional stages may assist with absorbing salt until the water reaches a nearly pure state (e.g., drinking water).

In various embodiments, the thermally responsive liquids (e.g., first thermally responsive liquid, second thermally responsive liquid, and/or at least one additional thermally responsive liquid) may be comprised of oleic acid and lidocaine (OA/LD) and water and can possess a lower critical solution temperature (LCST), such that the thermally responsive liquid may allow it to separate into two immiscible phases upon heating. In various embodiments, the two phases can be physically separated and cooled back down to ambient temperature. One phase can be water-rich (WR) and the other phase can be water-scarce (WS). In various embodiments, the water-scarce phase liquid can absorb moisture from liquids. In one or more embodiments, a predetermined concentration of salt (e.g., LiCl) may be added to the mixture before heating it up, however, can cause the operating range. However, by utilizing multiple stages, each thermally responsive liquid may comprise a different concentration of LiCl, such that the thermally responsive liquid may be configured to absorb different amounts of water.

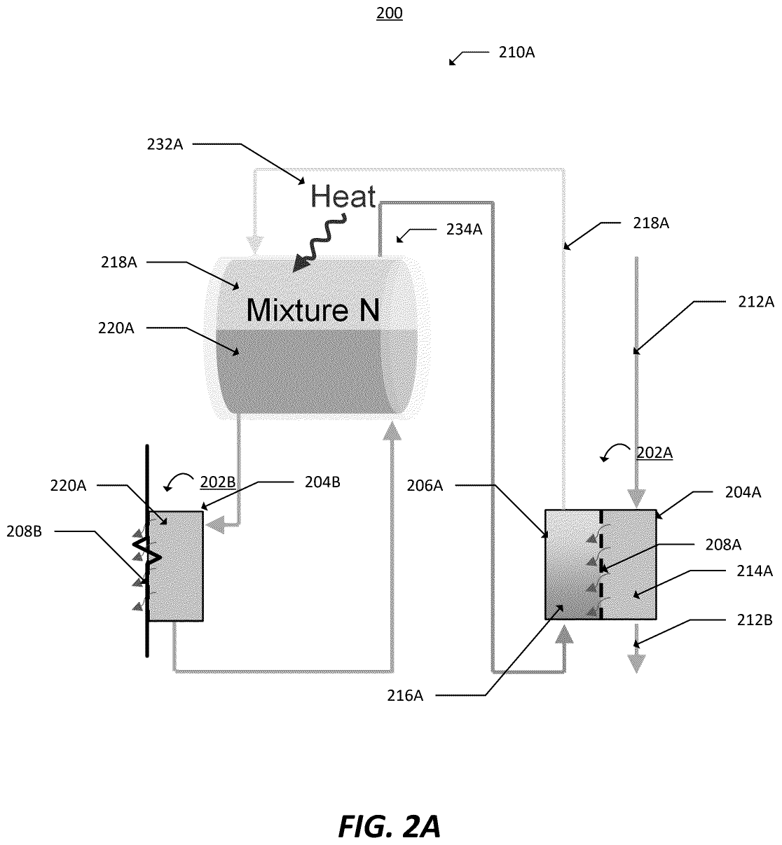

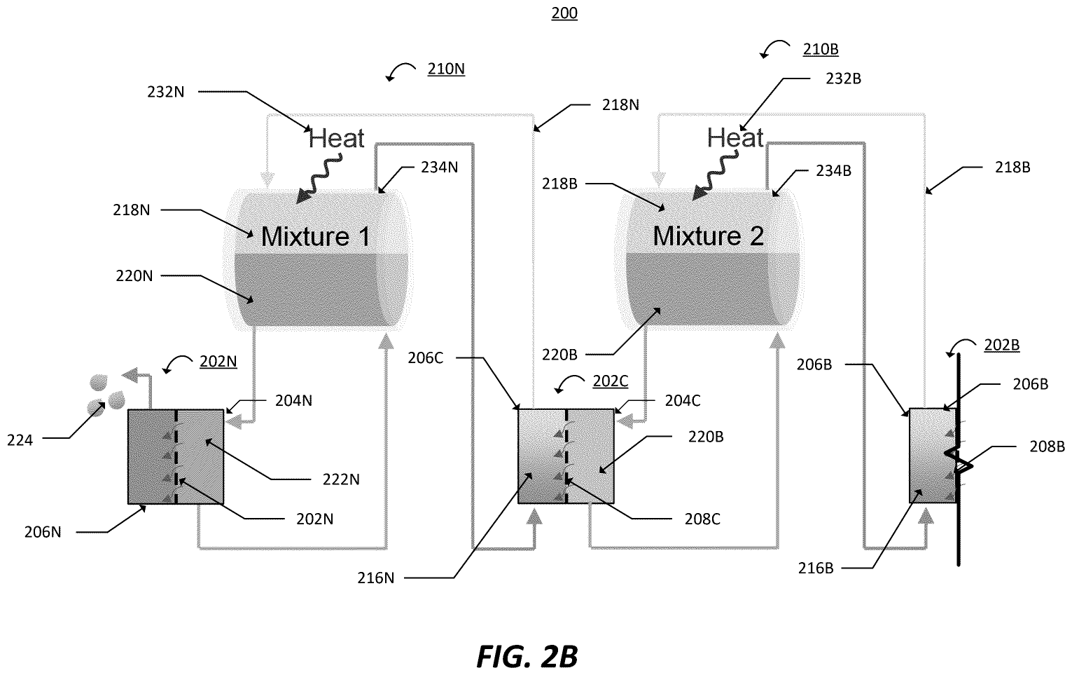

FIG. 2A illustrates an exemplary first stage 210A of a multistage desalination 200 in accordance with various embodiments of the present disclosure. An exemplary multistage desalination system 200 may comprise a first stage 210A, a second stage 210B (depicted in FIG. 2B), and/or at least one additional stage 210N (depicted in FIG. 2B). In various embodiments, the multistage desalination system may comprise at least a first liquid reservoir 202A, a first heater 232A, a first separator 234A, and/or at least a portion of the second liquid reservoir 202B. In various embodiments, the first liquid reservoir 202A and/or the second liquid reservoir 202B may comprise a rectangular configuration. In various embodiments, the first liquid reservoir 202A and/or the second liquid reservoir 202B may comprise a circular configuration, a square configuration, an ovular configuration, and/or any other desired configuration. In various embodiments, the first liquid reservoir 202A and/or the second liquid reservoir 202B may comprise a predetermined volume, such that the predetermined volume of the first liquid reservoir 202A and/or second liquid reservoir 202B may comprise a predetermined volume to receive a predetermined volume of liquid.

In various embodiments, the first liquid reservoir 202A may be divided into a first chamber 204A and a second chamber 206A by at least one membrane 208A. In various embodiments, the first chamber 204A of the first liquid reservoir 202A may be configured to receive a first saline liquid 212A (e.g., high saline liquid) comprising a first concentration of salt (e.g., highest concentration of salt). In one or more embodiments, in an instance in which the first chamber is full, at least a portion of the first saline liquid 212A may flow through the first chamber 204A through an outlet, such that the first saline liquid 212B may be recycled into the first chamber 204A. In various embodiments, the second chamber 206A of the first liquid reservoir 202A may be in liquid communication with the first separator 234A. The first separator 234A may at least partially fill the second chamber 206A of the first liquid reservoir 202A with a portion of the first thermally responsive liquid (e.g., first water-scarce phase liquid 216A). The first water-scarce phase liquid 216A may comprise a second concentration of salt, such that the second salt concentration is different (e.g., less than or greater than) than the first salt concentration. In various embodiments, the second salt concentration may change the absorption properties of the first water-scarce phase liquid 216A, such that the first water-scarce phase liquid 216A may absorb liquid (e.g., water) from the first saline liquid 212A.

In various embodiments, the first thermally responsive liquid 218A (e.g., first water-scarce phase liquid 216A with the absorbed water) may flow from the second chamber 206A of the first liquid reservoir 202A to the first separator 234A. In various embodiments, the first separator 234A may comprise a first heater 232A, such that the first heater 232A may assists with separating the first thermally responsive liquid 218A into the first water-scarce phase liquid 216A and the first water-rich phase liquid 220A. In various embodiments, the first separator 234A may be a separate component from the first heater 232A, such that the first heater 232A may assists with separating the first thermally responsive liquid 218A into the first water-scarce phase liquid 216A and the first water-rich phase liquid 220A. In various embodiments, the first heater 234A may be configured to utilize one or more of solar heat, waste heat, gas heat, electric heat, or a combination thereof to heat the first thermally responsive liquid to separate the first thermally responsive liquid into a first water-scarce phase liquid and a first water-rich phase liquid. The first water-rich phase liquid 220A may comprise a third salt concentration, such that the third salt concentration may be less than the first salt concentration and/or the second salt concentration.

In various embodiments, upon separation of the first thermally responsive liquid 218A into the first water-scarce phase liquid 218A and the first water-rich phase liquid 220A, the first water-scarce phase liquid 218A may be pumped back into the first chamber 206A of the first liquid reservoir and/or the first water-rich phase liquid 220A may flow to the first chamber 204B of a second liquid reservoir 202B. The second liquid reservoir 202B may comprise at least one second membrane 208B, such that the at least one second membrane 208B may allow at least a portion of the second saline liquid (e.g., first water-rich phase liquid 220A) to diffuse through the at least one second membrane 208B from the first chamber 204B of the second liquid reservoir 202B to the second chamber 206B of the second liquid reservoir 202B (depicted in FIG. 2B). In various embodiments, in an instance in which the first chamber 204B of the second reservoir 202B is full, at least a portion of the first water-rich liquid 220A may be recycled into one or more of the first separator 234A, the first heater 232A, the second liquid reservoir 202B, or a combination thereof.

FIG. 2B illustrates an exemplary second stage 210B and/or at least one additional stage 210N of a multistage desalination 200 in accordance with various embodiments of the present disclosure. In various embodiments, an exemplary multistage desalination system 200 (e.g., desalination system) may further comprise a second stage 210B and/or at least one additional stage 210N. In various embodiments, the desalination system 200 may further comprise a second liquid reservoir 202B, a second heater 232B, a second separator 234B, and/or a third liquid reservoir 202C. In one or more embodiments, the desalination system 200 may further comprise at least one additional heater 232N, at least one additional separator 234N, and/or at least one additional liquid reservoir 202N. In various embodiments, the salinity of the liquid decreases as a liquid moves to another stage of the multistage desalination system.

In various embodiments, the second liquid reservoir 202B, third liquid reservoir 202C, and/or at least one additional liquid reservoir 202N may comprise a rectangular configuration. In various embodiments, the second liquid reservoir 202B, third liquid reservoir 202C, and/or at least one additional liquid reservoir 202N may comprise a circular configuration, a square configuration, an ovular configuration, and/or any other desired configuration. In various embodiments, the second liquid reservoir 202B, third liquid reservoir 202C, and/or at least one additional liquid reservoir 202N may comprise a rectangular configuration and a predetermined volume, such that the predetermined volume of the second liquid reservoir 202B, third liquid reservoir 202C, and/or at least one additional liquid reservoir 202N may comprise a rectangular configuration may comprise a predetermined volume to receive a predetermined volume of liquid.

In various embodiments, the second liquid reservoir 202B may be divided into a first chamber 204B and/or a second chamber 206B by at least one second membrane 208B, the third liquid reservoir 202C may be divided into a first chamber 204C and/or a second chamber 206B by at least one third membrane 208C, and/or the at least one additional liquid reservoir 202N may be divided into a first chamber 204N and/or a second chamber 206N by at least one additional membrane 208N. In various embodiments, the first chamber 204B of the second liquid reservoir 202B may be configured to receive a second saline liquid 220A (e.g., first water-rich phase liquid) from the first separator 234A, such that the second saline liquid may comprise a third concentration of salt and the third concentration of salt is less than the first concentration and/or the second concentration. In various embodiments, the second chamber 206B of the second liquid reservoir 202B may be in liquid communication with the second separator 234B. The second separator 234B may provide the second chamber 206B of the second liquid reservoir 202B with at least a portion of the second thermally responsive liquid 218B (e.g., second water-scarce phase liquid 216B). The second water-scarce phase liquid 216B may comprise a fourth concentration of salt, such that the fourth salt concentration is less than the third salt concentration of the second saline liquid (e.g., first water-rich phase liquid 220A). In various embodiments, the fourth salt concentration may change the absorption properties of the second water-scarce phase liquid 216B, such that the second water-scarce phase liquid 216B may at least partially absorb liquid (e.g., water) from the second saline liquid 220A.

In various embodiments, the second thermally responsive liquid 218B (e.g., second water-scarce phase liquid 216B with the absorbed water) may flow from the second chamber 206B of the second liquid reservoir 202B to the second separator 234B. In various embodiments, the second separator 234B may comprise a second heater 232B, such that the second heater 232B may assists with separating the second thermally responsive liquid 218B into the second water-scarce phase liquid 216B and the second water-rich phase liquid 220B. In various embodiments, the second separator 234B may be a separate component from the second heater 232B, such that the second heater 232B may assists with separating the second thermally responsive liquid 218B into the second water-scarce phase liquid 216B and the second water-rich phase liquid 220B. In various embodiments, the second heater 234B may be configured to utilize solar heat, waste heat, gas heat, electric heat, or a combination thereof to heat the second thermally responsive liquid to separate the second thermally responsive liquid into a second water-scarce phase liquid and a second water-rich phase liquid.

In various embodiments, upon separation of the second thermally responsive liquid 218B into the second water-scarce phase liquid 216B and the second water-rich phase liquid 220B, the second water-scarce phase liquid 218B may flow back into the second chamber 206B of the second liquid reservoir 202B and/or the second water-rich phase liquid 220B may flow to the first chamber 204C of a third liquid reservoir 202C. In one or more other embodiment, the second water-rich phase liquid 220B may flow to at least one additional liquid reservoir 202N, such that the second water-rich phase liquid 220B may be pure drinking water and/or close to it. In various embodiments, the second water-rich phase liquid 220B (e.g., third saline liquid) may comprise a fifth salt concentration, such that the fifth salt concentrate may be less than the fourth salt concentration. In one or more embodiments, the fifth salt concentration may be equal to the salt concentration of pure drinking water.

In various embodiments, the third liquid reservoir 202C and/or at least one additional liquid reservoir 202N may comprise at least one third membrane 208C and/or at least one additional membrane 208N, respectively, such that the at least one third membrane 208C and/or at least one additional membrane 208N may allow at least a portion of the third saline liquid (e.g., second water-rich phase liquid 220B) to diffuse through the at least one third membrane 208C from the first chamber 204C of the third liquid reservoir 202C to the second chamber 206C of the third liquid reservoir 202C. In various embodiments, in an instance in which the first chamber 204C of the third reservoir 202C is full, at least a portion of the second water-rich liquid 220B may be recycled into one or more of the second separator 234B, the second heater 232B, the third liquid reservoir 202C, or a combination thereof.

With further reference to FIG. 2B, in various embodiments, the desalination system 200 may comprise at least one additional stage 210N. In various embodiments, the at least one additional stage 210N may comprise at least one additional reservoir 202N, at least one additional heater 232N, at least one additional separator 234N, and/or at least one additional thermally responsive liquid 218N. In various embodiments, the at least one separator 234N may be in fluid communication with the second chamber 206C of the third liquid reservoir 202C and/or with the first chamber 204N of the at least one additional liquid reservoir 202N. In various embodiments, the at least one additional thermally responsive liquid 218N may be heated by the at least one additional heater 232N, such that the at least one additional thermally responsive liquid 218N separates into at least one additional water-scarce phase liquid 216N and at least one additional water-rich liquid 220N.

In various embodiments, the at least one additional water-scarce phase liquid may flow from the at least one additional separator 234N to the second chamber 206C of the third liquid reservoir. In one or more embodiments, the at least one additional water-scarce phase liquid may comprise at least one additional salt concentration, such that the at least one additional salt concentration is different (e.g., less than or greater than) than the salt concentration of the third saline liquid (e.g., second water-rich phase liquid 220B). In various embodiments, the at least one additional water-scarce phase liquid 216N may at least partially absorb liquid (e.g., water) from the third saline liquid (e.g., second water-rich phase liquid 220B), such that the liquid may diffuse from the first chamber 204C of the third reservoir through at least one third membrane 208C to the second chamber 206C of the third liquid reservoir 202C. In various embodiments, the at least one additional thermally responsive liquid 218N (e.g., at least one additional water-scarce phase liquid with absorbed water) may flow from the second chamber 206N of the at least one additional liquid reservoir to the at least one additional separator 234N.

In one or more embodiments, the at least one additional water-rich phase liquid 220N may flow from the at least one additional separator 234N to at least one additional liquid reservoir 202N. In some embodiments, the at least one additional water-rich phase liquid 220N may flow into a first chamber 204N of the at least one additional liquid reservoir 204N. In various embodiments, the at least one additional liquid reservoir 202N may comprise at least one additional membrane 208N. The at least one additional membrane 208N may allow at least a portion of the at least one additional water-rich phase liquid 220N to diffuse through from the first chamber 204N of the at least one additional liquid reservoir 202N to the second chamber 206N of the at least one additional liquid reservoir 202N to the second chamber. In various embodiments, the portion of liquid that diffuses through the at least one additional membrane may be pure fresh water 224 and/or substantially pure fresh water 224.

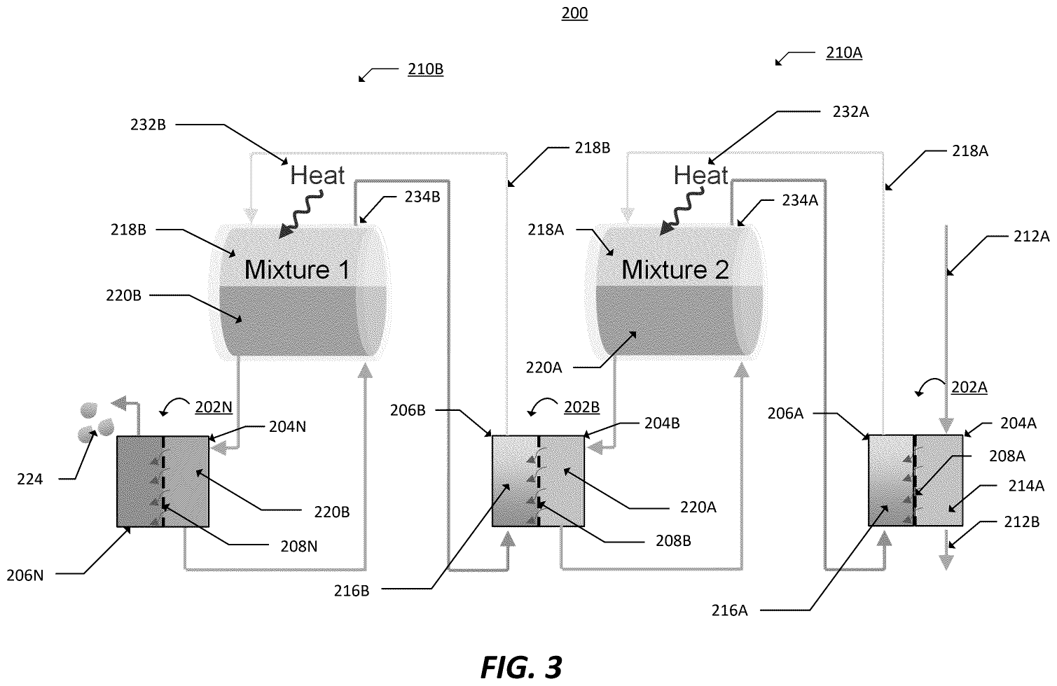

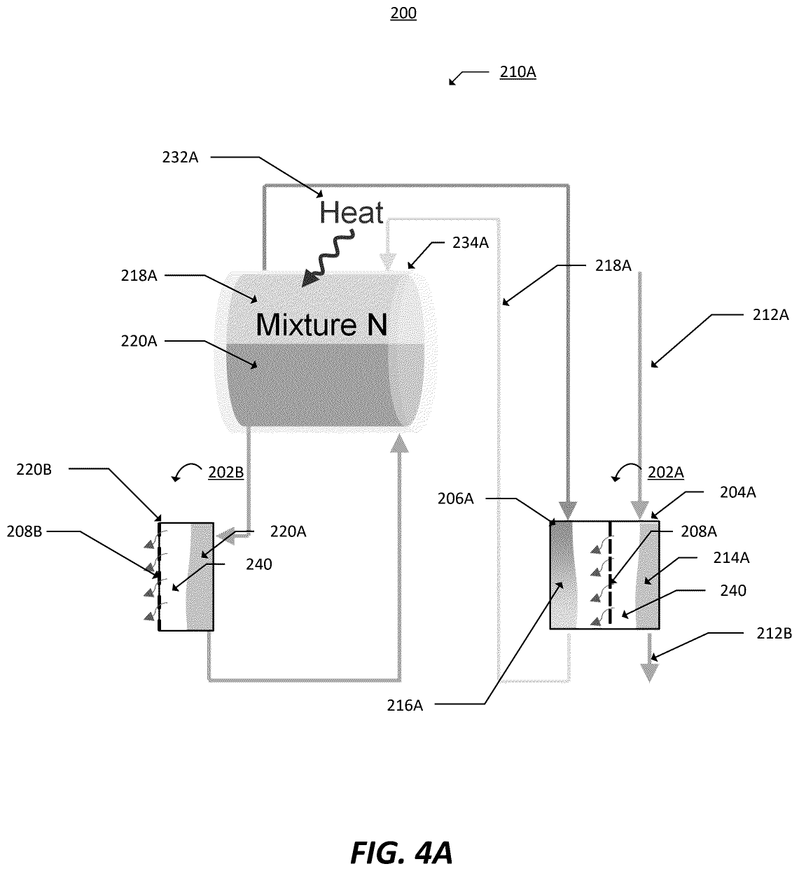

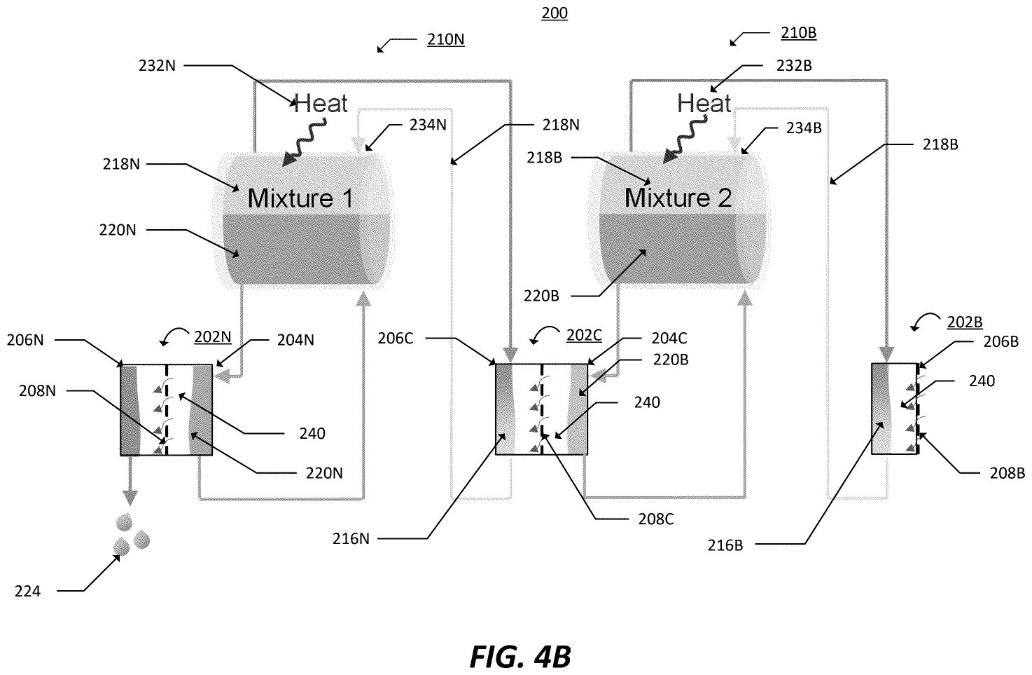

FIGS. 1A-4B illustrate exemplary desalination systems and portions thereof in accordance with various embodiments of the present disclosure. In various embodiments, the desalination systems 200 illustrated in FIGS. 3-4B are configured to perform the desalination function as described above. In various embodiments, the desalination system 200 may comprise a first stage 210A, a second stage 210B, and/or at least one additional stage 210N. In various embodiments, within each stage, a respective LCST mixture (e.g., thermally responsive liquid) may be heated within a respective heater and/or phase separated within a respective separator. In various embodiments, the first stage may comprise the same LCST mixture as the second stage and/or the at least one additional stage. In one or more embodiments, the first stage may comprise a different LCST mixture as the second stage and/or the at least one additional stage. In one or more embodiments, each stage has a different LCST mixture, either comprised of different chemical species, or the same chemical species in different concentrations (e.g., the concentration of LiCl increases with each subsequent stage).

In various embodiments, the first stage comprising Mixture 2 in FIG. 3 and Mixture N in FIG. 4A may be configured to receive a first saline feed water 212A in the first chamber 204A of the first liquid reservoir 202A, such that the first saline feed water 212A may pass by a water-permeable membrane 208A (e.g., only allows water to pass and block all other components). In various embodiments, the first saline feed water 212A may be completely saturated with NaCl and the desalination system 200 would still work. In various embodiments, a respective water-scarce phase liquid 216A, 216B, 216N (e.g., collectively “216”) of the Nth and/or 2nd LCST mixture flows into the second chamber 206A of the first liquid reservoir. In various embodiments, the chemical potential of water may be lower in the water-scarce phase liquid than in the first saline feed water 212A, such that water moves from the first saline feed water 212A through the at least one membrane to the water-scarce phase liquid in the second chamber of a respective liquid reservoir. In various embodiments, a respective thermally responsive liquid (e.g., water-scarce phase liquid having absorbed water) may enter a respective heater, such that the heater may cause water (e.g., water-rich phase liquid) to at least partially separate from the water-scarce phase liquid (e.g., LCST material).

In various embodiments, the water separated from a respective water-scarce phase liquid may be not entirely pure and still has some other chemical species mixed in it. In various embodiments, the water separated from a respective water-scarce phase liquid may flow through a second water permeable membrane and/or at least one additional water permeable membrane, such that additional water may be at least partially absorbed to a second water-scarce phase liquid in a 2−1th stage and/or at least one additional water-scarce phase liquid in a N−1th stage. In various embodiments, the chemical potential of water in the water-scarce phase of the 2−1th stage and/or the N−1th stage may be lower than the water-rich mixture in the first stage and/or Nth stage. In various embodiments, the water-scarce phase liquid of the N−1th stage is heated, transferring its water to a water-rich phase liquid, which itself transfers water through a membrane to stage N−2. This proceeds all the way down the line to a final stage. When the water-scarce phase liquid in a final stage may be heated, it may give up water to the water-rich phase liquid. In various embodiments, the water-rich phase liquid may be very pure (e.g., almost entirely water, very low concentration of any other chemical species) water and/or pure drinking water. In some embodiments, even though the water is very pure, it may need to be purified slightly more, so a very slight amount of pressure may be applied to the final stage water-rich phase liquid stream to force pure (fresh) water through the membrane.

In various embodiments, the at least one different stage in an exemplary desalination system 200 may utilize a different thermally responsive liquid comprising a LCST mixture. In one or more embodiments, the one or more LCST mixture (e.g., thermally responsive liquid) may comprise different chemical species. In other embodiments, two or more stages of a desalination system 200 may use the same chemical species, such that the same chemical species concentration in a first stage may different (e.g., greater concentration or lesser concentration) than the chemical species concentration in a second stage and/or at least one additional stage. In various embodiments, an exemplary thermally responsive liquid (e.g., LCST mixture) may comprise one or more of oleic acid, lidocaine, LiCl, water, or a combination thereof. In various embodiments, in an instance in which the concentration LiCl is different between each stage, the chemical potentials in each stage may be different (which is desired). As depicted in FIG. 3, in various embodiments, the mixture in the first stage may consist of an LCST material (e.g., oleic acid and lidocaine) and water. In one or more embodiments, the second mixture and/or at least one additional mixture in a second stage and/or at least one additional stage, respectively, may contain the same LCST material (e.g., oleic acid and lidocaine) and water, but with increasing amounts of a salt (e.g., LiCl).

FIGS. 4A-4B illustrate an exemplary desalination system and portions in accordance with various embodiments of the present disclosure. As depicted in FIGS. 4A-4B, in various embodiments, the desalination system may be a humidification-dehumidification desalination system 200 with a thermally responsive liquid comprising a LCST mixture. In various embodiments, the first thermally responsive liquid 218A may be heated by a first heater 232A and/or separated by the first separator 234A, such that the first thermally responsive liquid 218A may be separated into a first water-scarce phase liquid 216A and/or a water-rich phase liquid 220A. In various embodiments, the desalination system 200 may at least partially utilize air 240 to assist with diffusing at least a portion of the first saline liquid 214A in the first chamber 204A of the first liquid reservoir 202A through the at least one membrane 208A to the second chamber 206A of the first liquid reservoir 202A. In various embodiments, water may evaporate from the first saline liquid 214A feed stream in the first chamber 204A of the first liquid reservoir 202A, such that the chemical potential of the first water-scarce phase liquid 216A disposed at least partially in the second chamber 206A of the first liquid reservoir 202A may absorb at least a portion of the water through the at least one membrane 208A.

In various embodiments, the water may be configured to evaporate from a respective water-rich phase liquid (e.g., first water-rich phase liquid, second water-rich phase liquid, and/or one or more additional water-rich phase liquid) in a first chamber 204B, 204C, 204N of a second liquid reservoir 202B, a third liquid reservoir 202C, and/or at least one additional liquid reservoir 202N, respectively. In various embodiments, the second stage and/or the at least one additional stage may at least partially utilize air 240 to assist with diffusing at least a portion of a respective saline liquid (e.g., first water-rich phase liquid, second water-rich phase liquid, and/or one or more additional water-rich phase liquid) from a respective first chamber through at least one membrane to a respective second chamber.

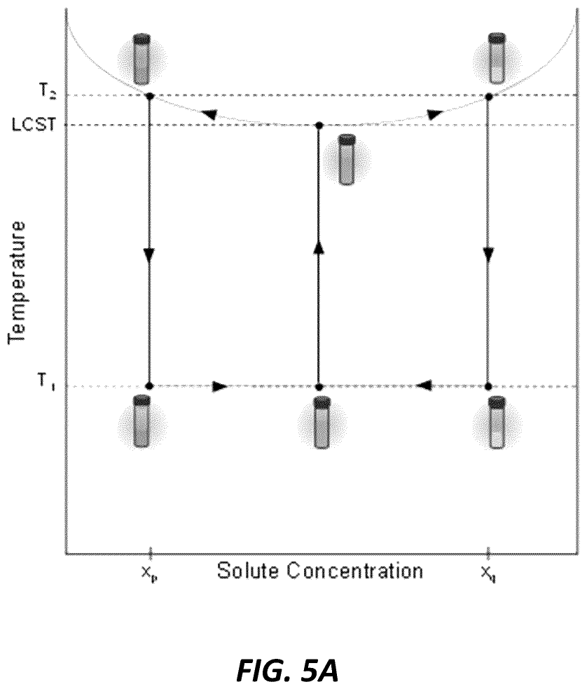

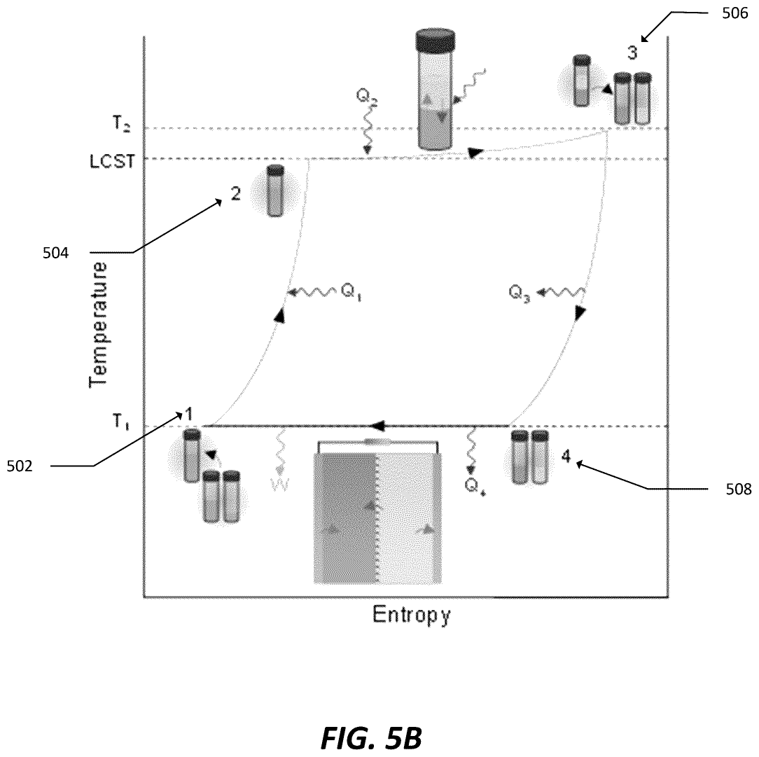

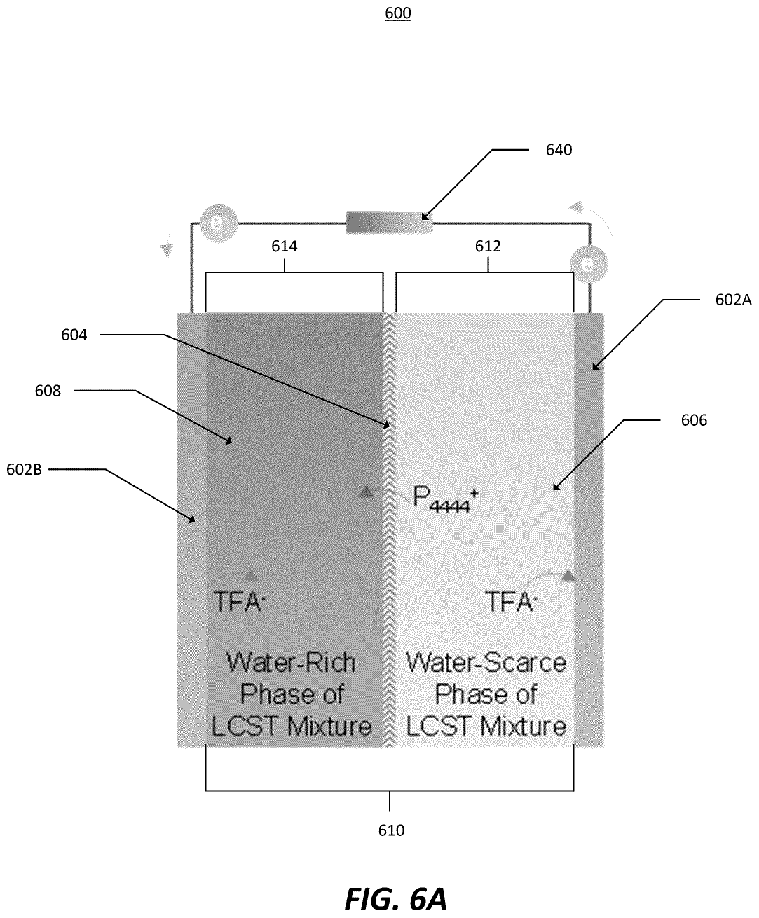

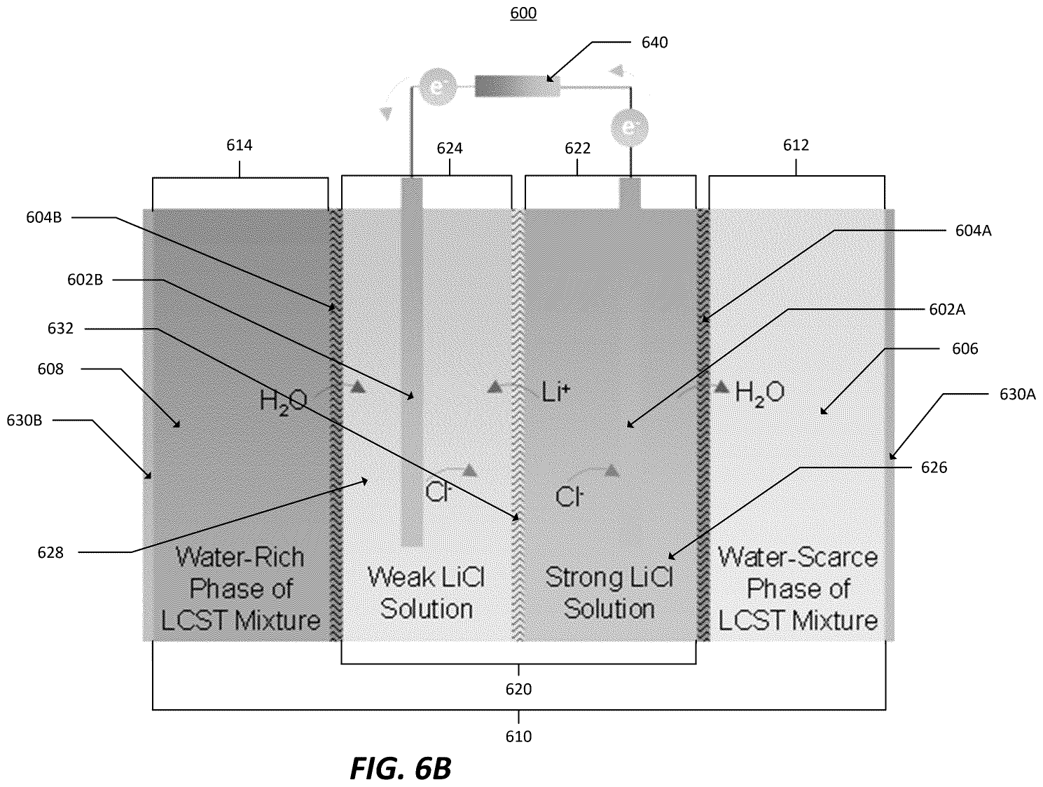

FIGS. 5A-5B illustrate exemplary phase diagram of a thermally responsive liquid comprising a lower critical solution temperature (LCST) used in a regenerative electrochemical cycle in accordance with various embodiments of the present disclosure. In various embodiments, as depicted in FIG. 5A, a phase diagram of an exemplary thermally responsive liquid comprising a lower critical solution temperature (LCST) is depicted. In various embodiments, a thermally responsive liquid may be comprised of a water-rich phase liquid and a water-scarce phase liquid. In various embodiments, the thermally responsive liquid may at least one solvent (e.g., water, water-rich phase liquid) and at least one solute (e.g., organic salt, polymer, and/or water-scarce phase liquid). In one or more embodiments, the water-rich phase liquid (e.g., solvent) and the water-scarce phase liquid (e.g., solute) may be homogenous (e.g., completely mixed) at room temperature. The water-rich phase liquid and the water-scarce phase liquid may be configured to separate when the thermally responsive liquid is heated to a temperature above the LCST. In various embodiments, the water-rich phase liquid and the water-scarce phase liquid may be physically separated from each other and/or cooled back down to room temperature, such that a concentration difference may allow the water-rich phase liquid and/or the water-scarce phase liquid to be used for one or more thermodynamic purposes, as described with reference to FIGS. 6A-8.

FIG. 5B illustrates an exemplary temperature versus entropy diagram for at least one thermally responsive liquid in accordance with various embodiments of the present disclosure. In various embodiments, at least one thermally responsive liquid comprising at least one LCST may be at an initial state 502 (e.g., first state) at an ambient temperature (T₁). The at least one thermally responsive liquid may be heated, with at least one heater using one or more of solar heat, waste heat, gas heat, electric heat, or a combination thereof, to a second temperature (T₂), such that the second temperature may be greater than the LCST and/or causes the water-rich phase liquid and the water-scarce phase liquid to at least partially separate, second state 504. In various embodiments, the water-rich phase liquid and the water-scarce phase liquid may be physically separated while the thermally responsive liquid is at a temperature greater than the LCST, third state 506. In various embodiments, the water-rich phase liquid and/or the water-scarce phase liquid may be cooled back to a temperature that is less than the LCST temperature. In various embodiments, a chemical potential difference between the water-scarce phase liquid and the water-rich phase liquid, fourth state 508, may be used to produce electrical power. In one or more embodiments, the two phases may be brought back to a same concentration and/or back into equilibrium with one another, thereby completing at least one cycle.

FIG. 6A-6B illustrate exemplary power generation systems with LCST regenerative electrochemical cycles 600 (LCSTRECs) in accordance with various embodiments of the present disclosure. With reference to FIG. 6A, in various embodiments, a power generation system 600 may comprise at least a first liquid reservoir 610, a first thermally responsive liquid, a first electrode 602A, and/or a second electrode 602B. In various embodiments, the first thermally responsive liquid may comprise a first water-scarce phase liquid 606 and a first water-rich phase liquid 608. In one or more embodiments, the first water-scarce phase liquid 606 may be configured to at least partially absorb a portion of the first water-rich phase liquid 608, such that the first water-scarce phase liquid with the absorbed first water-rich phase liquid forms the first thermally responsive liquid. In other embodiments, the first water-rich phase liquid 608 may be configured to at least partially absorb a portion of the first water-scarce phase liquid 606, such that the first water-rich phase liquid with the absorbed first water-scarce phase liquid forms the first thermally responsive liquid.

In various embodiments, the first liquid reservoir 610 may comprise at least one membrane 604. The at least one membrane may comprise one or more of a predetermined desired shape, configuration, thickness, material, position, or a combination thereof to perform a desired function. In various embodiments, the at least one membrane 604 may divide the first liquid reservoir 610 into a first chamber 612 and a second chamber 614. In one or more embodiments, the at least one membrane 604 may divide the first liquid reservoir 610 evenly, such that the first chamber 612 and the second chamber 614 may comprise equal volumes. In other embodiments, the at least one membrane 604 may divide the first liquid reservoir 610 unevenly, such that the first chamber 612 and the second chamber 614 may comprise different (e.g., less than or greater than) volumes. In various embodiments, the at least one membrane 604 may be one or more of a cation exchange membrane, a water-permeable membrane, or a combination thereof. The at least one membrane 604 may be further configured to selectively allow at least a portion of the first thermally responsive liquid cations to pass through from a first chamber 612 to a second chamber 614 and/or from a second chamber 614 to a first chamber 612.

With further reference to FIG. 6A, in various embodiments, the power generation system 600 may further comprise a first heater (e.g., not depicted, similar to a heater described in reference to FIGS. 1A-4B), such that the first heater may heat the first thermally responsive liquid to a temperature that may be at least the first LCST to separate the first thermally responsive liquid into the first water-scarce phase liquid 606 and the first water-rich phase liquid 608. In various embodiments, the first heater may be configured to use one or more of solar heat, waste heat, gas heat, electric heat, or a combination thereof. In one or more embodiments, the power generation system 600 may further comprise a first separator (e.g., not depicted, similar to a heater described in reference to FIGS. 1A-4B). The first separator may be at least partially separate the first thermally responsive liquid into the first water-scarce phase liquid and the first water-rich phase liquid.

With even further reference to FIG. 6A, in various embodiments, the first chamber 612 of the first liquid reservoir 610 may be fluidically communicative with the first heater and/or first separator, such that the first chamber 612 may receive one or more of the first water-rich phase liquid 608, first water-scarce phase liquid 606, or a combination thereof. In various embodiments, the second chamber 614 of the first liquid reservoir 610 may be fluidically communicative with the first heater and/or first separator, such that the first chamber 612 may receive one or more of the first water-rich phase liquid 608, first water-scarce phase liquid 606, or a combination thereof. In an example embodiment, the first chamber 612 may be configured to receive the first water-scarce phase liquid 606 and/or the second chamber 614 may be configured to receive the first water-rich phase liquid 608. In another embodiment, the second chamber 614 may be configured to receive the first water-scarce phase liquid 606 and/or the first chamber 612 may be configured to receive the first water-rich phase liquid 608.

In various embodiments, the first electrode 602A and/or the second electrode 602B may be configured to define at least a portion (e.g., side wall) of the first liquid reservoir 610. In various embodiments, the first electrode 602A may be disposed at least partially within the first chamber 612 or within the second chamber 614 and/or the second electrode 602B may be disposed at least partially within the second chamber 614 and/or within the first chamber 612. In various embodiments, at least one membrane 604 may at least partially separate the first chamber 612 and the second chamber 614. The at least one membrane 604 may be a cation exchange membrane. In various embodiments, the at least one membrane 604 may allow at least one electron to flow from a first chamber 612, through the at least one membrane 604, to the second chamber 614 or from the second chamber 614, through the at least one membrane 604, to the first chamber.

In various embodiments, the first water-scarce phase liquid 606 and the first water-rich phase liquid 608 may be separated by a at least one cation exchange membrane 604. The first water-rich phase liquid 608 and the first water-scarce phase liquid may comprise different chemical concentrations (e.g., therefore different chemical potentials). In various embodiments, the different chemical concentrations may cause a redox reaction, such that one side may give up an electron (oxidation) and/or may cause the electron to flow to the other side (electrical current) and combine with the species on the other side (reduction). For example, in FIG. 6A, the power generation system 600 may comprise at least one cation exchange membrane 604 that may be permeable to the LCST cation (e.g., P₄₄₄₄⁺), while the electrode would need to react with the LCST anion (e.g., TFA⁻). In various embodiments, the at least one electron may flow to the first electrode 602A and/or to the second electrode 602B. In various embodiments, the first electrode 602A and/or the second electrode 602B may be connected to a load 640, such that the load 640 may cause the electrons to flow from the first electrode 602A to the second electrode 602B or from the second electrode 602B to the first electrode 602A. The flowing of the at least one electron between the first electrode 602A and/or the second electrode 602B may generate electrical power.

FIG. 6B illustrates an exemplary power generation system 600 in accordance with various embodiments of the present disclosure. In various embodiments, the power generation system 600 may comprise a first liquid reservoir 610, at least one additional liquid reservoir 620 (e.g., second liquid reservoir), a first electrode 602A, a second electron 602B, a first thermally responsive liquid, and/or an aqueous electrolyte. In various embodiments, the power generation system may further comprise at least one membrane 604A, 604B (collectively “604” and/or at least one additional membrane 633. In one or more embodiments, the at least one membrane 604 and/or the at least one additional membrane 632 may be one or more or a cation exchange membrane, a water permeable membrane, or a combination thereof.

In various embodiments, the first thermally responsive liquid may comprise a first water-scarce phase liquid 606 and a first water-rich phase liquid 608. In one or more embodiments, the first water-scarce phase liquid 606 may be configured to at least partially absorb a portion of the first water-rich phase liquid 608, such that the first water-scarce phase liquid with the absorbed first water-rich phase liquid forms the first thermally responsive liquid. In other embodiments, the first water-rich phase liquid 608 may be configured to at least partially absorb a portion of the first water-scarce phase liquid 606, such that the first water-rich phase liquid with the absorbed first water-scarce phase liquid forms the first thermally responsive liquid. In various embodiments, the aqueous electrolyte may comprise a second lower critical solution temperature (LCST). The aqueous electrolyte may be disposed at least partially within the second liquid reservoir 620. In various embodiments, the aqueous electrolyte may comprise a weak aqueous electrolyte phase liquid 628 and/or a strong aqueous electrolyte phase liquid 626.

In various embodiments, the first liquid reservoir 610 may comprise at least one additional membrane 604. The at least one membrane 604 may comprise one or more of a predetermined desired shape, configuration, thickness, material, position, or a combination thereof to perform a desired function. In various embodiments, the at least one membrane 604 may divide the first liquid reservoir 610 into a first chamber 612 and a second chamber 614. In one or more embodiments, the at least one membrane 604 may divide the first liquid reservoir 610 evenly, such that the first chamber 612 and the second chamber 614 may comprise equal volumes. In other embodiments, the at least one membrane 604 may divide the first liquid reservoir 610 unevenly, such that the first chamber 612 and the second chamber 614 may comprise different (e.g., less than or greater than) volumes. In various embodiments, the at least one membrane 604 may be one or more of a cation exchange membrane, a water-permeable membrane, or a combination thereof. The at least one membrane 604 may be further configured to selectively allow at least a portion of the first thermally responsive liquid cations to pass through from a first chamber 612 to a second chamber 614 and/or from a second chamber 614 to a first chamber 612. In various embodiments, a first membrane 604A may divide the first chamber 612 of the first liquid reservoir 610 from the first chamber 622 of the second liquid reservoir 620 and/or a second membrane 604B may divide the second chamber 614 of the first liquid reservoir 610 from the second chamber 624 of the second liquid reservoir 620.

Wither further reference to FIG. 6B, in various embodiments, the second liquid reservoir 620 may be disposed at least partially within the first liquid reservoir 610. In one or more embodiments, the second liquid reservoir 620 may be disposed in the middle of the first liquid reservoir 610. In other embodiments, the second liquid reservoir 620 may be disposed in any desired location within the first liquid reservoir 610. In various embodiments, the first chamber 622 of the second liquid reservoir 620 may be fluidically communicative with the first chamber 612 of the first liquid reservoir 610 and/or the second chamber 624 of the second liquid reservoir 620 may be fluidically communicative with the second chamber 612 of the first liquid reservoir 610.

In various embodiments, the second liquid reservoir 620 may comprise at least one membrane 604. The at least one additional membrane 632 may comprise one or more of a predetermined desired shape, configuration, thickness, material, position, or a combination thereof to perform a desired function. In various embodiments, the at least one additional membrane 632 may divide the second liquid reservoir 620 into a first chamber 622 and a second chamber 624. In one or more embodiments, the at least one additional membrane 632 may divide the second liquid reservoir 620 evenly, such that the first chamber 622 and the second chamber 624 may comprise equal volumes. In other embodiments, the at least one additional membrane 632 may divide the second liquid reservoir 620 unevenly, such that the first chamber 622 and the second chamber 624 may comprise different (e.g., less than or greater than) volumes. In various embodiments, the at least one additional membrane 632 may be one or more of a cation exchange membrane, a water-permeable membrane, or a combination thereof. The at least one additional membrane 632 may be further configured to selectively allow at least a portion of the first thermally responsive liquid cations to pass through from a first chamber 622 to a second chamber 624 and/or from a second chamber 624 to a first chamber 622.

With further reference to FIG. 6B, in various embodiments, the power generation system 600 may further comprise a first heater (e.g., not depicted, similar to a heater described in reference to FIGS. 1A-4B), such that the first heater may heat the first thermally responsive liquid to a temperature that may be at least the first LCST to separate the first thermally responsive liquid into the first water-scarce phase liquid 606 and the first water-rich phase liquid 608. The power generation system 600 may further comprise a second heater (e.g., not depicted, similar to a heater described in reference to FIGS. 1A-4B), such that the second heater may heat the second thermally responsive liquid to a temperature that may be at least the second LCST to separate the second thermally responsive liquid into the weak aqueous electrolyte phase liquid 628 and the strong aqueous electrolyte phase liquid 626. In various embodiments, the first heater and/or the second heater may be configured to use one or more of solar heat, waste heat, gas heat, electric heat, or a combination thereof.

In one or more embodiments, the power generation system 600 may further comprise a first separator (e.g., not depicted, similar to a heater described in reference to FIGS. 1A-4B). The first separator may be at least partially separate the first thermally responsive liquid into the first water-scarce phase liquid and the first water-rich phase liquid. The power generation system 600 may further comprise a second separator (e.g., not depicted, similar to a heater described in reference to FIGS. 1A-4B). The second separator may be at least partially separate the weak aqueous electrolyte phase liquid 628 and the strong aqueous electrolyte phase liquid 626. In one or more embodiments, the power generation system may comprise one heater and one separator configured to heat and separate the first thermally responsive liquid into the first water-scarce phase liquid and the first water-rich phase liquid and/or heat and separate the second thermally responsive liquid into the weak aqueous electrolyte phase liquid and the strong aqueous electrolyte phase liquid.

With even further reference to FIG. 6B, in various embodiments, the first chamber 612 of the first liquid reservoir 610 may be fluidically communicative with the first heater and/or first separator, such that the first chamber 612 may receive one or more of the first water-rich phase liquid 608, first water-scarce phase liquid 606, or a combination thereof. In various embodiments, the second chamber 614 of the first liquid reservoir 610 may be fluidically communicative with the first heater and/or first separator, such that the first chamber 612 may receive one or more of the first water-rich phase liquid 608, first water-scarce phase liquid 606, or a combination thereof. In an example embodiment, the first chamber 612 may be configured to receive the first water-scarce phase liquid 606 and/or the second chamber 614 may be configured to receive the first water-rich phase liquid 608. In another embodiment, the second chamber 614 may be configured to receive the first water-scarce phase liquid 606 and/or the first chamber 612 may be configured to receive the first water-rich phase liquid 608.

In various embodiments, the first chamber 622 of the second liquid reservoir 620 may be fluidically communicative with the second heater and/or second separator, such that the first chamber 622 may receive one or more of the weak aqueous electrolyte phase liquid 628, strong aqueous electrolyte phase liquid 626, or a combination thereof. In various embodiments, the second chamber 624 of the second liquid reservoir 620 may be fluidically communicative with the second heater and/or second separator, such that the second chamber 624 may receive one or more of the weak aqueous electrolyte phase liquid 628, strong aqueous electrolyte phase liquid 626, or a combination thereof. In an example embodiment, the first chamber 622 may be configured to receive the strong aqueous electrolyte phase liquid 628 and/or the second chamber 624 may be configured to receive the weak aqueous phase liquid 626. In another embodiment, the second chamber 624 may be configured to receive the strong aqueous electrolyte phase liquid 626 and/or the first chamber 622 may be configured to receive the weak aqueous electrolyte phase liquid 628.

In various embodiments, the first electrode 602A and/or the second electrode 602B may be configured to define at least a portion (e.g., side wall) of the second liquid reservoir 620. In various embodiments, the first electrode 602A may be disposed at least partially within the first chamber 622 or within the second chamber 624 of the second liquid reservoir and/or the second electrode 602B may be disposed at least partially within the second chamber 624 and/or within the first chamber 622 of the second liquid reservoir. In various embodiments, at least one membrane 604 may at least partially separate the first chamber 612 and the second chamber 614. The at least one membrane 604 may be a cation exchange membrane. In various embodiments, the at least one membrane 604 may allow at least one electron to flow from a first chamber 612, through the at least one membrane 604, to the second chamber 614 or from the second chamber 614, through the at least one membrane 604, to the first chamber.

In various embodiments, the first water-scarce phase liquid 606 may be separated from the strong aqueous electrolyte phase liquid 626 by at least water permeable exchange membrane 604A and/or the first water-rich phase liquid 608 may be separated from the weak aqueous electrolyte phase liquid 628 by at least one water permeable membrane 604B. The strong aqueous electrolyte phase liquid 626 and the weak aqueous electrolyte phase liquid 628 may be separated by at least one cation exchange membrane 632. In an example embodiment, the aqueous electrolyte may be lithium chloride (LiCl). In the example embodiment, the cation exchange membrane 632 may be configured to selectively allow at least one Li+ ions to pass, while the first electrode 602A and/or the second electrode 602B may attract at least one Cl− ions (silver electrodes can achieve this). In the example embodiment, the first membrane 604A and/or the second membrane 604B may be water permeable membranes. The first membrane 604A and/or the second membrane 604B may separate the LCST mixture from the electrolyte. In various embodiments, the chemical potential difference between the LCST mixtures produces a chemical potential difference between the electrolyte across the cation exchange membrane, which may result in a voltage, and correspondingly the flow of current and power. In various embodiments, the first electrode 602A and/or the second electrode 602B may be connected to a load 640, such that the load 640 may cause the electrons to flow from the first electrode 602A to the second electrode 602B or from the second electrode 602B to the first electrode 602A. The flowing of the at least one electron between the first electrode 602A and/or the second electrode 602B may generate electrical power.

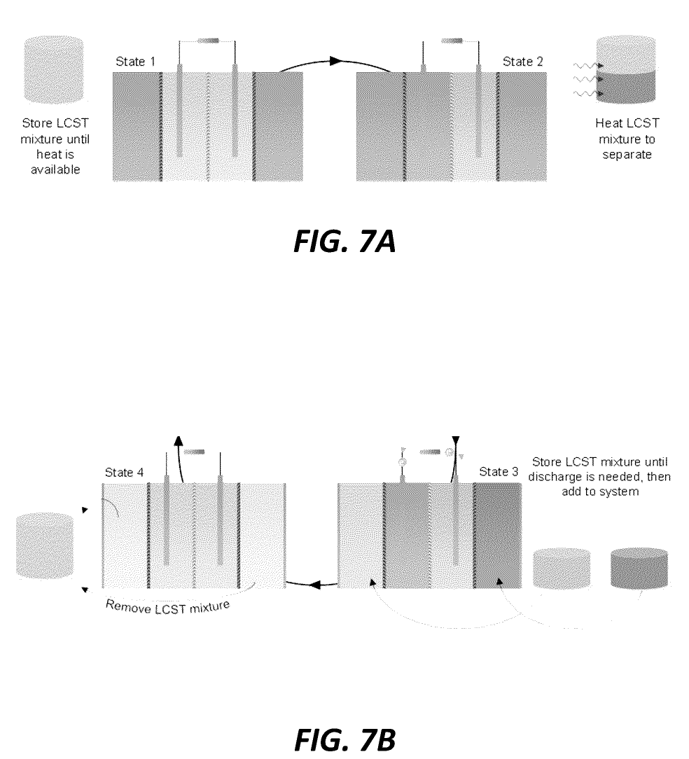

FIGS. 7A-7B illustrate exemplary stages of a power generation system in accordance with various embodiments of the present disclosure. In various embodiments, a respective heating process of the LCST Regenerative Electrochemical Cycle (LCSTREC) may be illustrated in FIG. 7A. During state 1 to state 2, the thermally responsive liquid may be stored until heat is available to regenerate the mixture (e.g., the mixture maye stored overnight until sunlight can be used to heat the mixture). In various embodiments state 2 to state 3 may cause the thermally responsive liquid to be heated and separated. In various embodiments, the separated thermally responsive liquid may be stored indefinitely (e.g., may be stored until power is needed). In various embodiment, when power is needed, the first thermally responsive may be added to the system (e.g., to the second thermally responsive liquid). Once the first thermally responsive liquid is in the system and a load may be connected to the first electrode and/or the second electrode and may cause the system to produce electrical power (discharge), state 3 to state 4. After state 4, the first thermally responsive liquid may be removed from the system to be regenerated again.

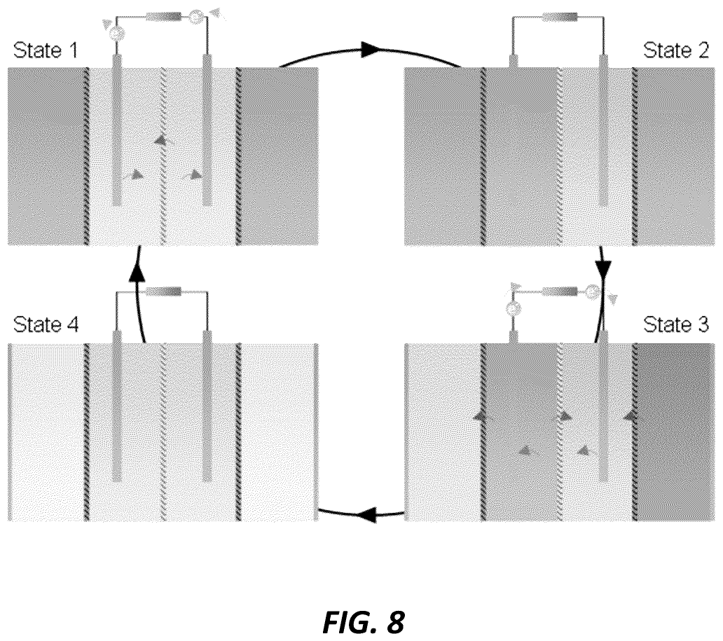

FIG. 8 illustrate electrical power that is produced by an exemplary power generation system in accordance with various embodiments of the present disclosure. In various embodiments, FIG. 8 may illustrate an exemplary schematic of the LCST Regenerative Electrochemical Cycle (LCSTREC) (e.g., power generation system). In state 1 to state 2 voltage may be applied to the electrolyte solution, to concentrate the electrolyte on the left side of the system. In state 2 to state 2, the LCST mixture (which is not yet inside the system) may be heated and separated. Once separated, the two phases can be stored indefinitely, until it is time to discharge the cell. Once needed, the water-rich phase liquid (WR) and/or the water-scarce phase liquid (WS) may be added to the respective chambers. In state 3 to state 4, the power generation system may be configured to produce electrical power by at least one electron flowing between the first electrode and the second electrode. In state 4 to 1, the LCST mixture may be removed from the system to cause the system to be regenerated. During the subsequent cycle, the direction of the cycle must be reversed (i.e., electrolyte is concentrated to the right during process 1-2, and the WR phase is added to the left side at state 3).

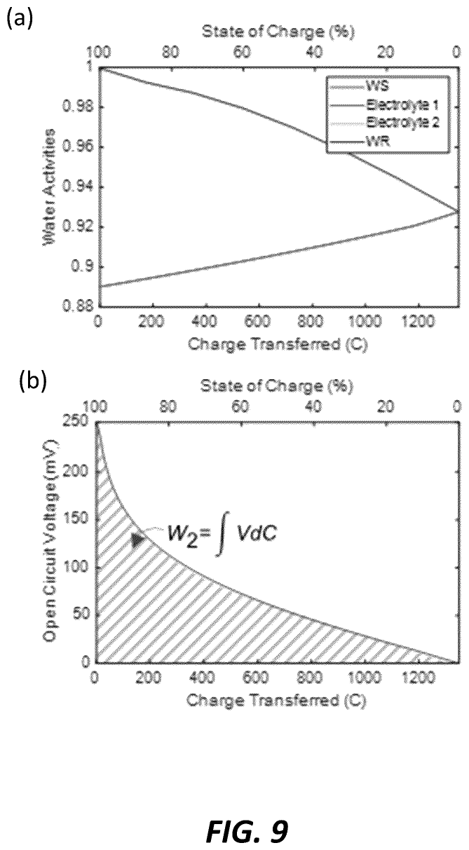

FIG. 9 graphically illustrates results of the power generation system in accordance with various embodiments of the present disclosure. In various embodiments, (a) may graphically illustrate the water activity (the driving force for the flow of electricity) as function of the charge of the cell during the power generation process (e.g., during one or more regenerative cycles). In various embodiments, (b) may graphically illustrate open circuit voltage as a function of cell charge, such that the integration of the voltage may cause the power generation system to yield the power produced during discharge.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A desalination system, the desalination system comprising:
a first liquid reservoir comprising a first chamber and a second chamber, the first chamber configured to receive a first saline liquid having a first salt concentration, the second chamber configured to receive a first thermally responsive liquid having a second salt concentration less than the first salt concentration, wherein the first thermally responsive liquid is configured to absorb water from the first saline liquid;
a first heater configured to heat the first thermally responsive liquid to separate the first thermally responsive liquid into a first water-scarce phase liquid and a first water-rich phase liquid, the first water-rich phase liquid having a third salt concentration less than the first salt concentration;
a second liquid reservoir comprising a first chamber and a second chamber, the first chamber configured to receive the first water-rich phase liquid, the second chamber configured to receive a second thermally responsive liquid having a fourth salt concentration less than the third salt concentration, wherein the second thermally responsive liquid is configured to absorb water from the first water-rich phase; and
a second heater configured to heat the second thermally responsive liquid to separate the second thermally responsive liquid into a second water-scarce phase liquid and a second water-rich phase liquid, the second water-rich phase liquid having a fifth salt concentration less than the third salt concentration.

2. The desalination system of claim 1, wherein the first heater and/or the second heater comprises one or more of solar heat, waste heat, gas heat, electric heat, or a combination thereof.

3. The desalination system of claim 2, the system further comprising:
a first separator configured to separate the first thermally responsive liquid into the first water-scarce phase liquid and the first water-rich phase liquid; and
a second separator configured to separate the second thermally responsive liquid into the second water-scarce phase liquid and the second water-rich phase liquid.

4. The desalination system of claim 3, wherein the first separator is in fluid communication with the second chamber of the first liquid reservoir, wherein the first separator is configured to receive the first thermally responsive fluid with the absorbed water from the first saline liquid and return the first water-scarce phase liquid to the second chamber of the first liquid reservoir.

5. The desalination system of claim 4, wherein the first separator is in fluid communication with the second liquid reservoir, wherein the first separator is configured to deliver the first water-rich phase liquid to the first chamber of the second liquid reservoir.

6. The desalination system of claim 5, wherein the second separator is in fluid communication with the second chamber of the second liquid reservoir, wherein the second separator is configured to receive the second thermally responsive fluid with the absorbed water from the first water-rich phase liquid and return the second water-scarce phase liquid to the second chamber of the second liquid reservoir.

7. The desalination system of claim 6, wherein the second separator is in fluid communication with a third liquid reservoir, wherein the second separator is configured to deliver the second water-rich phase liquid to the third liquid reservoir.

8. The desalination system of claim 1, wherein the first liquid reservoir comprises at least one membrane, wherein the first liquid reservoir is configured such that water from the first saline liquid in the first chamber diffuses through the at least one membrane and into the first thermally responsive liquid in the second chamber.

9. The desalination system of claim 8, wherein the second liquid reservoir comprises at least one membrane, wherein the second liquid reservoir is configured such that water from the first water-rich phase liquid in the first chamber diffuses through the at least one membrane and into the second thermally responsive liquid in the second chamber.

10. The desalination system of claim 9, wherein the system is configured to take salt collected by the at least one membrane of the second liquid reservoir and inject the salt into the first thermally responsive liquid in the second chamber of the first liquid reservoir.

11. A power generation system, the power generation system comprising:
a first liquid reservoir comprising at least one membrane dividing the first liquid reservoir into a first chamber and a second chamber;
a first thermally responsive liquid having a first lower critical solution temperature (LCST) within at least a portion of the first liquid reservoir, wherein the first thermally responsive liquid is configured to be separated into a first water-scarce phase liquid and a first water-rich phase liquid upon heating, wherein the first water-scarce phase liquid and the first water-rich phase liquid comprise different chemical potentials, wherein a portion of the first water-scarce phase liquid is configured to flow from the first chamber, through the at least one membrane, and to the second chamber; and
a first electrode and a second electrode,
wherein at least one electron is configured to flow from the first electrode to the second electrode to generate electrical power.

12. The power generation system of claim 11, wherein the at least one membrane is one or more of a cation exchange membrane, a water-permeable membrane, or a combination thereof and is configured to selectively allow the first thermally responsive liquid cations to pass.

13. The power generation system of claim 11, wherein the first electrode is disposed at least partially within the first chamber, wherein the first chamber houses either of the first water-scarce phase liquid or the first water-rich phase liquid and/or the second electrode is disposed at least partially within the second chamber of the first liquid reservoir, wherein the second chamber houses either of the first water-scarce phase liquid or the first water-rich phase liquid.

14. The power generation system of claim 11, the system further comprising:
a first heater configured to heat the first thermally responsive liquid to a temperature that is at least the first LCST to separate the first thermally responsive liquid into the first water-scarce phase liquid and the first water-rich phase liquid.

15. The power generation system of claim 14, wherein the first heater comprises one or more of solar heat, waste heat, gas heat, electric heat, or a combination thereof.

16. The power generation system of claim 15, the system further comprising:
a first separator configured to separate the first thermally responsive liquid into the first water-scarce phase liquid and the first water-rich phase liquid.

17. The power generation system of claim 16, the system further comprising:
a second liquid reservoir disposed at least partially within the first liquid reservoir and comprising at least one additional membrane dividing the second liquid reservoir into a second first chamber and a second chamber, wherein the at least one additional membrane is one or more of a cation exchange membrane, a water-permeable membrane, or a combination thereof;
an aqueous electrolyte having a second lower critical solution temperature (LCST) within at least a portion of the second liquid reservoir, wherein the aqueous electrolyte is configured to be separated into a weak aqueous electrolyte phase liquid and a strong aqueous electrolyte phase liquid;
a second heater configured to heat the aqueous electrolyte to a temperature that is at least the second LCST to separate the aqueous electrolyte into the weak aqueous electrolyte phase liquid and the strong aqueous electrolyte phase liquid, wherein the second heater comprises one or more of solar heat, waste heat, gas heat, electric heat, or a combination thereof; and
a second separator configured to separate the aqueous electrolyte into the weak aqueous electrolyte phase liquid and the strong aqueous electrolyte phase liquid.

18. The power generation system of claim 17, wherein the first electrode is disposed at least partially within the second first chamber of the second liquid reservoir, wherein the second first chamber houses either the weak aqueous electrolyte phase liquid or the strong aqueous electrolyte phase liquid and/or the second electrode is disposed at least partially within the second chamber of the second liquid reservoir, wherein the second chamber houses either the weak aqueous electrolyte phase liquid and the strong aqueous electrolyte phase liquid.

19. The power generation system of claim 18, wherein a first membrane is a water-permeable membrane and diffuses water to flow from the first thermally responsive liquid within at least a portion of the first liquid reservoir, through the first membrane, and to the aqueous electrolyte within at least a portion of the second liquid reservoir and/or from the aqueous electrolyte within at least a portion of the second liquid reservoir, through the first membrane, and to at least a portion of the first thermally responsive liquid within at least a portion of the first liquid reservoir.

20. The power generation system of claim 17, wherein the at least one additional membrane is configured to allow at least one cation to flow through the at least one additional membrane, wherein at least one anion is configured to flow to the first electrode and/or to the second electrode, wherein the flow of the at least one anion is configured to generate electrical power.
